(19) United States
(12) Patent Application Publication
(10) Pub. No.: US 2009/0243287 A1
(43) Pub. Date: Oct. 1, 2009

(54) DOWN SPOUT CLEAN-OUT ADAPTER

(76) Inventor: Kevin C. Travis, Carrollton, TX (US)

Correspondence Address: Daniel V. Thompson;Thompson & Gustavson, LLP, 9304 Forest Lane, Suite N253, Dallas, TX, 75243, US

(21) Appl. No.: 12/060,580

(22) Filed: Apr. 1, 2008

(51) Int. Cl. F16L 35/00

(52) U.S. Cl. 285/328

(57) ABSTRACT

A down spout clean-out adapter has a tubular pipe, a deflector plate sized and configured to snugly interfit with the tubular pipe to divert and expel the flow of debris and water from the tubular pipe, and a sleeve being rotatable between normal and clean-out configurations, where in the normal configuration the sleeve seals the opening in the tubular pipe, and where in the clean-out configuration the sleeve exposes the opening.

### FIELD OF THE INVENTION

The present invention relates in general to rain gutters. More specifically, but without restriction to the particular use which is shown and described, this invention relates to an adapter for enabling the clean out of gutter downspouts.

### BACKGROUND OF THE INVENTION

One of the unfortunate chores associated with building maintenance is cleaning out the debris that accumulates in the rain gutters. This debris is usually comprised of a decomposing mixture of acorns, leaves, insects and other organic matter. Leaving this material to accumulate in the rain gutters and downspouts can lead to a number of problems, the most obvious being that the rain gutter system will no longer function to carry the rain water away from the building. When the rain gutters overflow, the rain water is deposited right next to the building where it can flood basements, weaken foundations, and destroy landscaping.

While the chore of cleaning rain gutters is absolutely necessary, it can be unpleasant and potentially dangerous. The chore is unpleasant because of the smell and texture of the decomposing debris. Also, unfortunately, rain gutters tend to fill with debris mostly during the fall and winter seasons when the trees drop their leaves and acorns. Most rain gutters are mounted just below the roofline, which is usually at least eight feet from ground level. To clean the gutters, the homeowner will usually climb a ladder and reach from side to side scooping debris from rain gutter. The danger of falling from the ladder while off balance reaching from side to side is apparent.

Debris also travels down the downspout and into the drain line. A downspout is normally comprised of an elongated tubular section running vertically from the rain gutter to the drain line. The drain line often extends away from the building to an outlet, or in some systems leads to a large perforated pipe that is buried in a bed of gravel that circles the perimeter of the building. Removing the debris that accumulates and clogs downspouts and drain lines is very difficult and often quite expensive. For instance, a clogged downspout might be unblocked by forcing a plumber's snake down it from its top end (from a ladder eight or more feet up), but when the clog is freed, the debris will flow into the drain line. Alternatively, the downspout can be removed from the building, flushed, and then reinstalled. A clogged drain line would probably have to be removed and replaced—a very expensive procedure.

One approach to enabling the easy and effective clean out of gutters and down spouts is disclosed in U.S. Pat. No. 6,024,127 to Wm. R. Johnson. In the Johnson device, a rectangular door is provided for insertion into an opening in the down spout to drain line adapter, with the door acting to divert flow of debris and water external to the adapter prior to entry into the drain line. The rectangular door is stowed to seal the opening in normal operation. Drawbacks of this prior device are that it is difficult to manufacture and use, has poor aesthetics and is hard to paint, and presents obstructions to flow in normal operation.

### SUMMARY OF THE INVENTION

A down spout clean-out adapter has a tubular pipe, a deflector plate sized and configured to snugly interfit with the tubular pipe to divert and expel the flow of debris and water from the tubular pipe, and a sleeve being rotatable between normal and clean-out configurations, where in the normal configuration the sleeve seals the opening in the tubular pipe, and where in the clean-out configuration the sleeve exposes the opening.

### BRIEF DESCRIPTION OF DRAWINGS

A more complete understanding of the invention and its advantages will be apparent from the Detailed Description taken in conjunction with the accompanying Drawings, in which:

FIG. 1 is a perspective view of the down spout clean-out adapter used in a gutter system;

FIG. 2 is a perspective view of the down spout clean-out adapter being used in a down spout clean-out operation;

FIG. 3 a perspective view of the down spout clean-out adapter being used in a drain clean-out operation;

FIG. 4 is a partially broken away side view of the down spout clean-out adapter; and

FIGS. 5, 6 and 7 are perspective views illustrating the rotatable sleeve and deflector plate of the down spout clean-out adapter.

### DETAILED DESCRIPTION

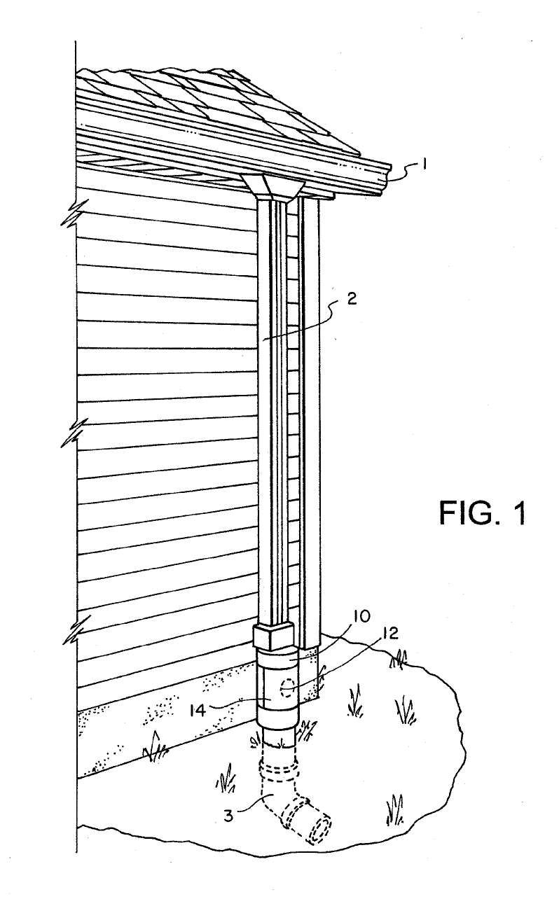

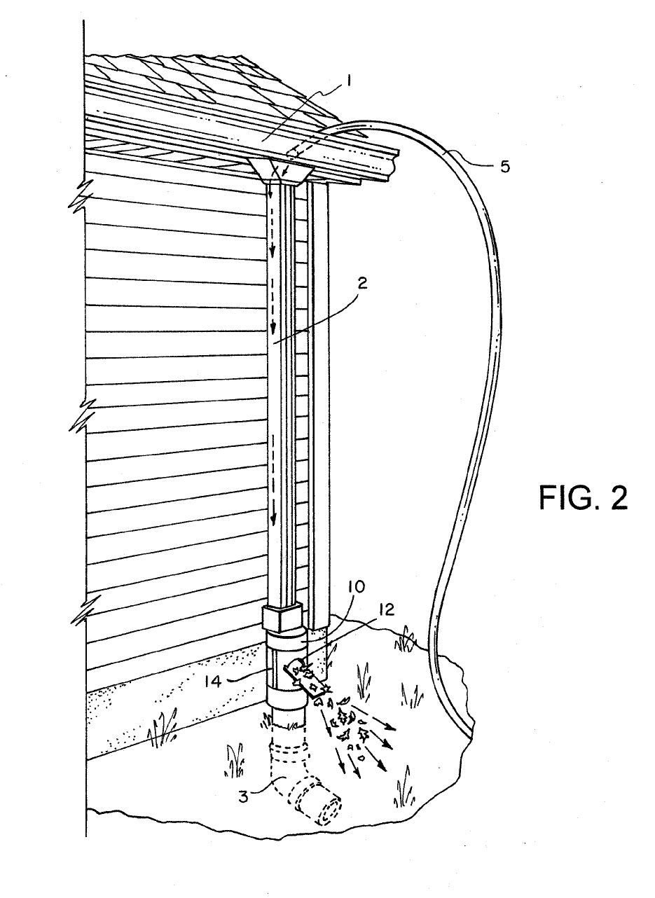

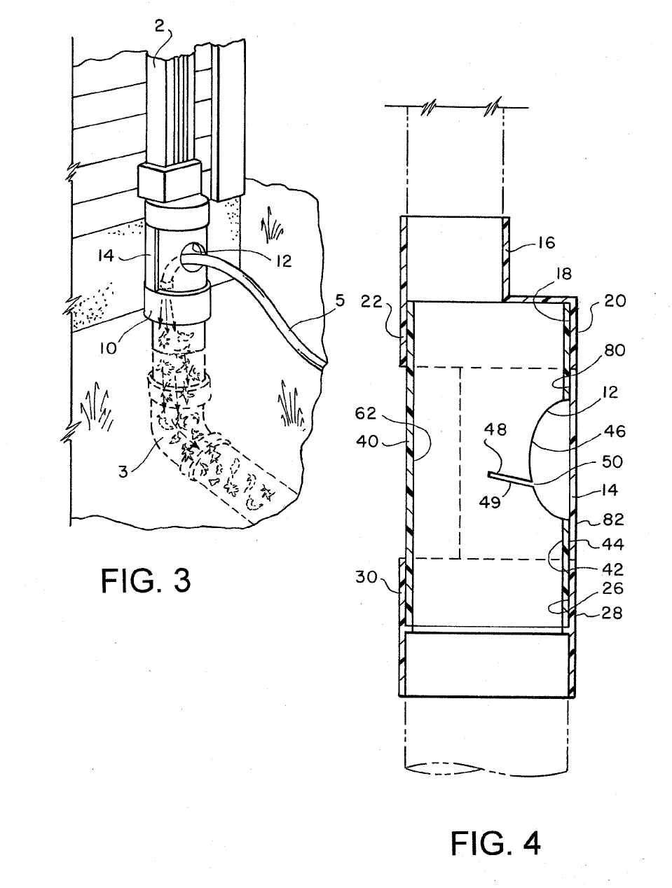

Referring initially to FIGS. 1, 2 and 3, a residential gutter system includes gutter 1, down spout 2, drain 3, and down spout clean-out adapter 10. Adapter 10 includes an opening 12, which in normal operation is sealed by a sleeve 14, as shown in FIG. 1. Sleeve 14 is rotatable to expose opening 12, as shown in FIG. 2, to permit a clean-out operation on down spout 2 from above with a hose 5, where debris exits the system. An alternate clean-out operation is shown in FIG. 3, where hose 5 inserted into opening 12 permits the clean-out of drain 3.

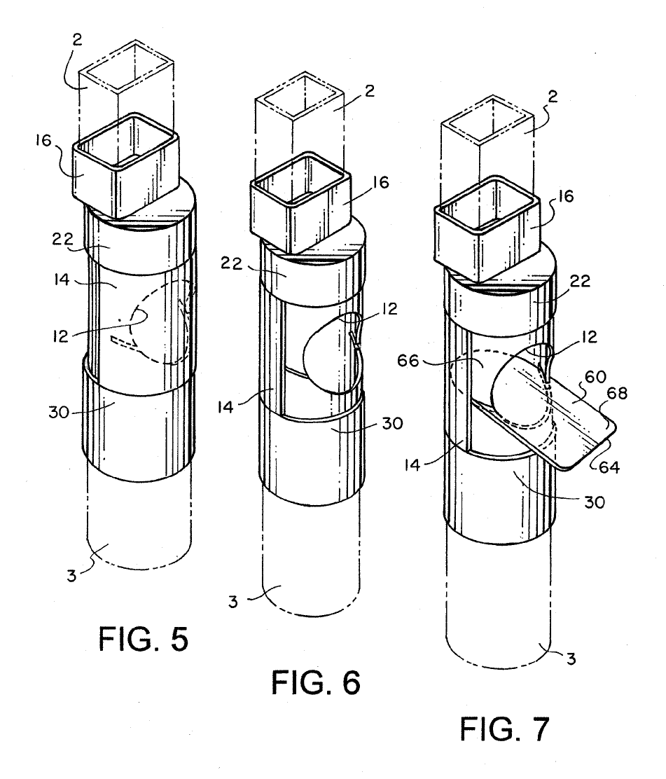

Referring now to FIGS. 4-7, in detail down spout clean-out adapter 10 includes previously mentioned opening 12 and sleeve 14. An upper connector 16 connects to down spout 2. The upper connector 16 has internal and external cylindrical surfaces 18, 20 at a lower end 22. Lower connector 24 is provided for connection to drain line 3. The lower connector 24 has internal and external cylindrical surfaces 26, 28 at an upper end 30.

Tubular pipe 40 has internal and external cylindrical surfaces 42, 44 of constant diameter. Tubular pipe 40 extends between the upper and lower connectors 16, 24, with the tubular pipe external surface 44 fitted to the internal cylindrical surfaces 18, 26 of the upper connector lower end 22 and the lower connector upper end 30, respectively.

Walls 46 in the tubular pipe form the circular opening 12 between the internal and external surfaces 42, 44 of the tubular pipe 40. Walls 48, 49 in the tubular pipe 40 form linear slots 50 at each side of the circular opening 12. The linear slots 50 are angled upwardly away from the opening 12 about 15 degrees from horizontal.

As shown in FIG. 7, a deflector plate 60 is sized and configured to snugly interfit with the linear slots 50 and extend from an internal back surface 62 of the tubular pipe 40 to an edge 64 located externally and a distance away from the tubular pipe 40, to divert and expel the flow of debris and water from the tubular pipe 40 as shown in FIG. 2. The deflector plate 60 has a curved end 66 closely interfitting with the internal back surface 62 of the tubular pipe 40. Edge 64 is located on a square 68 end opposite the curved end 66.

Sleeve 14 has an inner surface 80 snugly and closely interfitted with the external surface 44 of the tubular pipe 40. The sleeve 14 is partially tubular, spanning about 210 degrees about the tubular pipe 40. Sleeve 14 is rotatable between normal and clean-out configurations, where in the normal configuration the sleeve seals the opening in the tubular pipe, and where in the clean-out configuration the sleeve exposes the opening. Sleeve 40 has an outer surface 82 substantially flush with the adjacent portion of the upper connector lower end external surface 20 and an adjacent portion of the lower connector upper end external surface 28, as best shown in FIG. 4.

In operation, to clean the gutter system, it is necessary to simply turn rotating sleeve 14 to expose the opening 12 in the tubular pipe 40. Deflector plate 60 is then inserted into slots 50 on each side of opening 12 until curved end 66 is flush with internal back surface 62 of tubular pipe 40. To remove leaves and debris, hose 5 is inserted in the gutter above the selected down spout as shown in FIG. 2 and the water turned on. Flow must be monitored to ensure water does not back up and overflow the gutter, but with moderate flow debris should be easily evacuated from the down spout via the deflector plate. Once the down spout is cleaned out, the deflector plate 60 is removed and the hose inserted into opening 14 as shown in FIG. 3. This enables the underground drain 3 to be flushed with debris exiting at a remoter exhaust point.

Compared to prior clean-out adapters, my invention is easier to manufacture and easier to use because it has fewer specially-formed parts. Aesthetics are better, because the adapter blends in with existing down spouts and drains and cam be made of similar plastic fittings and pipes. My adapter is easier to paint and will not corrode when formed of plastic. The clean-out opening can be formed more largely, and there are fewer internal flow restrictions.

It will be understood that each of the elements described above, or two or more together, may also find a useful application in other types of constructions differing from the type described above.

While the invention has been illustrated and described as embodied in a particular down spout clean-out adapter, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A down spout clean-out adapter, comprising;
a tubular pipe having internal and external cylindrical surfaces of constant diameters;
walls in the tubular pipe forming an opening between the internal and external surfaces of the tubular pipe;
walls in the tubular pipe forming linear slots at each side of the opening; and
a deflector plate sized and configured to snugly interfit with the linear slots and extend from an internal back surface of the tubular pipe to an edge located externally and a distance away from the tubular pipe, to divert and expel the flow of debris and water from the tubular pipe.

2. The down spout clean-out adapter of claim 1 with the tubular pipe opening being circular.

3. The down spout clean-out adapter of claim 1 with the linear slots being angled upwardly away from the opening about 15 degrees from horizontal.

4. The down spout clean-out adapter of claim 2 with the linear slots being angled upwardly away from the opening about 15 degrees from horizontal.

5. The down spout clean-out adapter of claim 1 with the deflector plate having a curved end closely interfitting with the internal back surface of the tubular pipe.

6. The down spout clean-out adapter of claim 4 with the deflector plate having a curved end closely interfitting with the internal back surface of the tubular pipe.

7. The down spout clean-out adapter of claim 6 with the deflector plate having a square end opposite the curved end.

8. The down spout clean-out adapter of claim 1, with
an upper connector for connection to a gutter system down spout;
the upper connector having internal and external cylindrical surfaces at a lower end;
a lower connector for connection to a drain line;
the lower connector having internal and external cylindrical surfaces at an upper end; and
the tubular pipe extending between the upper and lower connectors, with the tubular pipe external surface fitted to the internal cylindrical surfaces of the upper connector lower end and the lower connector upper end.

9. The down spout clean-out adapter of claim 5, with
an upper connector for connection to a gutter system down spout;
the upper connector having internal and external cylindrical surfaces at a lower end;
a lower connector for connection to a drain line;
the lower connector having internal and external cylindrical surfaces at an upper end; and
the tubular pipe extending between the upper and lower connectors, with the tubular pipe external surface fitted to the internal cylindrical surfaces of the upper connector lower end and the lower connector upper end.

10. The down spout clean-out adapter of claim 1, with
a sleeve having an inner surface snugly and closely interfitted with the external surface of the tubular pipe; and
the sleeve being rotatable between normal and clean-out configurations, where in the normal configuration the sleeve seals the opening in the tubular pipe, and where in the clean-out configuration the sleeve exposes the opening.

11. The down spout clean-out adapter of claim 10 with the sleeve being partially tubular, spanning about 210 degrees about the tubular pipe.

12. A down spout clean-out adapter, comprising;
a tubular pipe having internal and external cylindrical surfaces of constant diameters;
walls in the tubular pipe forming an opening between the internal and external surfaces of the tubular pipe;
a sleeve having an inner surface snugly and closely interfitted with the external surface of the tubular pipe; and
the sleeve being rotatable between normal and clean-out configurations, where in the normal configuration the sleeve seals the opening in the tubular pipe, and where in the clean-out configuration the sleeve exposes the opening.

13. The down spout clean-out adapter of claim 12, with
an upper connector for connection to a gutter system down spout;
the upper connector having internal and external cylindrical surfaces at a lower end;
a lower connector for connection to a drain line;
the lower connector having internal and external cylindrical surfaces at an upper end; and
the tubular pipe extending between the upper and lower connectors, with the tubular pipe external surface fitted to the internal cylindrical surfaces of the upper connector lower end and the lower connector upper end.

14. The down spout clean-out adapter of claim 12 with the sleeve being partially tubular, spanning about 210 degrees about the tubular pipe.

15. The down spout clean-out adapter of claim 13 with the sleeve being partially tubular, spanning about 210 degrees about the tubular pipe.

16. The down spout clean-out adapter of claim 8, with the sleeve having an outer surface substantially flush with an adjacent portion of the upper connector lower end external surface and an adjacent portion of the lower connector upper end external surface.

17. The down spout clean-out adapter of claim 11, with the sleeve having an outer surface substantially flush with an adjacent portion of the upper connector lower end external surface and an adjacent portion of the lower connector upper end external surface.

18. The down spout clean-out adapter of claim 13, with the sleeve having an outer surface substantially flush with an adjacent portion of the upper connector lower end external surface and an adjacent portion of the lower connector upper end external surface.

19. The down spout clean-out adapter of claim 12, with
the tubular pipe opening being circular;
walls in the tubular pipe forming an opening between the internal and external surfaces of the tubular pipe;
walls in the tubular pipe forming linear slots at each side of the opening;
the linear slots being angled upwardly away from the opening about 15 degrees from horizontal; and
a deflector plate having a curved end closely interfitting with an internal back surface of the tubular pipe.

20. A down spout clean-out adapter, comprising;
an upper connector for connection to a gutter system down spout;
the upper connector having internal and external cylindrical surfaces at a lower end;
a lower connector for connection to a drain line;
the lower connector having internal and external cylindrical surfaces at an upper end;
a tubular pipe having internal and external cylindrical surfaces of constant diameters;
the tubular pipe extending between the upper and lower connectors, with the tubular pipe external surface fitted to the internal cylindrical surfaces of the upper connector lower end and the lower connector upper end;
walls in the tubular pipe forming a circular opening between the internal and external surfaces of the tubular pipe;
walls in the tubular pipe forming linear slots at each side of the circular opening;
the linear slots being angled upwardly away from the opening about 15 degrees from horizontal;
a deflector plate sized and configured to snugly interfit with the linear slots and extend from an internal back surface of the tubular pipe to an edge located externally and a distance away from the tubular pipe, to divert and expel the flow of debris and water from the tubular pipe;
the deflector plate having a curved end closely interfitting with the internal back surface of the tubular pipe;
the deflector plate having a square end opposite the curved end;
a sleeve having an inner surface snugly and closely interfitted with the external surface of the tubular pipe;
the sleeve being partially tubular, spanning about 210 degrees about the tubular pipe;
the sleeve being rotatable between normal and clean-out configurations, where in the normal configuration the sleeve seals the opening in the tubular pipe, and where in the clean-out configuration the sleeve exposes the opening; and
the sleeve having an outer surface substantially flush with an adjacent portion of the upper connector lower end external surface and an adjacent portion of the lower connector upper end external surface.
